(19) United States
(12) Patent Application Publication
(10) Pub. No.: US 2010/0067973 A1
(43) Pub. Date: Mar. 18, 2010

(54) CASE IDENTIFICATION SYSTEM

(76) Inventor: Seema Lopez, Gilbert, AZ (US)

Correspondence Address: BOOTH UDALL, PLC, 1155 W. Rio Salado Pkwy., Suite 101, Tempe, AZ, 85281, US

(21) Appl. No.: 12/327,389

(22) Filed: Dec. 3, 2008

Related U.S. Application Data
(60) Provisional application No. 61/098,205, filed on Sep. 18, 2008.

(51) Int. Cl. B42F 13/40; B42D 1/00

(52) U.S. Cl. 402/3; 281/15.1

(57) ABSTRACT

A case system comprises a case and one or more identification plugs. The case comprises two or more surfaces, and at least one surface of the two or more surfaces comprises a plurality of holes disposed thereabout. The plurality of holes sized and shaped to accept and maintain in position one or more identification plugs. The one or more identification plugs comprise a post portion sized and shaped to selectively mate with at least one of the plurality of holes.

### CROSS REFERENCE TO RELATED APPLICATIONS

This document claims the benefit of the filing date of U.S. Provisional Patent Application 61/098,205 to Seema Lopez entitled “Decorative Cases,” which was filed on Sep. 18, 2008, the disclosure of which is hereby incorporated herein by reference.

### BACKGROUND

1. Technical Field

Aspects of this document relate generally to case systems comprising one or more cases having one or more removable, replaceable identification plugs.

2. Background Art

Individuals and businesses frequently store personal and business effects in cases. There are many types of cases, from specific types of cases for specific purposes, to general types of cases for general purpose use. Due to mass-manufacturing and other considerations, many cases are similar in appearance to many other cases. Similar looking cases may cause some inconvenience when one user takes a similar-looking case that does not belong to them. Accordingly, what is needed is a system providing for the ready customization and identification of cases.

### SUMMARY

In one aspect, a case system comprises a case and one or more identification plugs. The case includes two or more surfaces, with at least one surface of the two or more surfaces comprising a plurality of holes disposed thereabout. The plurality of holes are sized and shaped to accept and maintain in position one or more identification plugs. The one or more identification plugs comprise a post portion sized and shaped to selectively mate with at least one of the plurality of holes.

Particular implementations of a case system may include one or more of the following. At least two of the two or more surfaces may one of oppose one another and may be adjacent to one another. The plurality of holes may be one of: disposed randomly about the at least one surface; arranged linearly about the at least one surface; arranged curvilinearly about the at least one surface; arranged equidistantly with respect to one another about the at least one surface; and arranged to form one or more designs about the at least one surface. The plurality of holes may each be one of substantially equal in diameter and comprise a variety of diameters. The plurality of holes may comprise a variety of depths. At least one of the plurality of holes may pass through the at least one surface. The plurality of holes may comprise a variety of perimeter shapes. At least a portion of at least one of the plurality of holes may be located substantially above the at least one surface. The one or more identification plugs may further comprise an identification portion coupled with the post portion. The one or more identification plugs may further comprise a retaining portion coupled with the post portion. A shape of the post portion may be complementary to a shape of one or more of the plurality of holes.

In another aspect, a case system comprises a case and one or more identification plugs. The case comprises two or more surfaces, at least one surface of the two or more surfaces having a plurality of anchor points disposed thereabout. The plurality of anchor points are sized and shaped to accept and maintain in position one or more identification plugs. The one or more identification plugs each comprise an anchor portion sized and shaped to selectively mate with at least one of the plurality of anchor points.

Particular implementations of a case system may include one or more of the following. At least two of the two or more surfaces may one of oppose one another and may be adjacent to one another. The plurality of anchor points may be one of: disposed randomly about the at least one surface; arranged linearly about the at least one surface; arranged curvilinearly about the at least one surface; arranged equidistantly with respect to one another about the at least one surface; and arranged to form one or more designs about the at least one surface. The plurality of anchor points may comprise a variety of depths. At least one of the plurality of anchor points may pass through the at least one surface. The plurality of anchor points may comprise a variety of perimeter shapes. At least a portion of at least one of the plurality of anchor points may be located substantially above the at least one surface. The one or more identification plugs may further comprise an identification portion coupled with the anchor portion. The one or more identification plugs may further comprise a retaining portion coupled with the anchor portion. A shape of the anchor portion may be complementary to a shape of one or more of the plurality of anchor points.

In another aspect, a case comprises two or more surfaces, at least one surface of the two or more surfaces comprising a plurality of holes disposed thereabout. The plurality of holes are sized and shaped to accept and maintain in position one or more identification plugs.

Particular implementations of a case system may include one or more of the following. The one or more identification plugs may be maintained in position with respect to at least one of the plurality of holes via impingement of an identification plug retaining portion upon the at least one surface. The one or more identification plugs may be maintained in position with respect to at least one of the plurality of holes via the impingement of an identification plug retaining portion within at least one of the one or more holes. The one or more identification plugs may be maintained in position with respect to at least one of the plurality of holes via the impingement of a identification plug post portion within the at least one surface.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Case systems comprising one or more cases having one or more removable, replaceable identification plugs, cases having one or more holes sized and shaped to accommodate one or more identification plugs, and identification plugs configured to selectively mate with one or more holes in one or more implementations of cases will hereinafter be described in conjunction with the appended drawings, where like designations denote like elements, and:

FIG. 1 is a front view of a first particular implementation of a case system with the case in a closed position and identified with a plurality of a identification plugs;

FIG. 2 is a front perspective view of a first particular implementation of a case system, the case in a closed position and customized with a plurality of a identification plugs;

FIG. 3 is a perspective view of a first particular implementation of a case system in an open position, the case customized with a plurality of a identification plugs;

FIG. 4 is a top perspective view of a first particular implementation of a case system, the case in an open position and identified with a plurality of a identification plugs;

FIG. 5 is a perspective view of a first particular embodiment of an identification plug;

FIG. 6 is a front view of a second particular implementation of a case;

FIG. 7 is a front view of a third particular implementation of a case;

FIG. 8 is a front view of a fourth particular implementation of a case;

FIG. 9 is a front view of a fifth particular implementation of a case; and

FIG. 10 is a front view of a sixth particular implementation of a case.

### DESCRIPTION

This document features various implementations of case systems comprising one or more cases having one or more removable, replaceable identification plugs. This document also features various implementations of cases having one or more holes sized and shaped to accommodate one or more identification plugs. This document further features various implementations of identification plugs configured to selectively mate with one or more holes in one or more implementations of cases described herein. There are many features of the various case systems, cases, and identification plugs disclosed herein, of which one, a plurality, or all features may be used in any particular implementation.

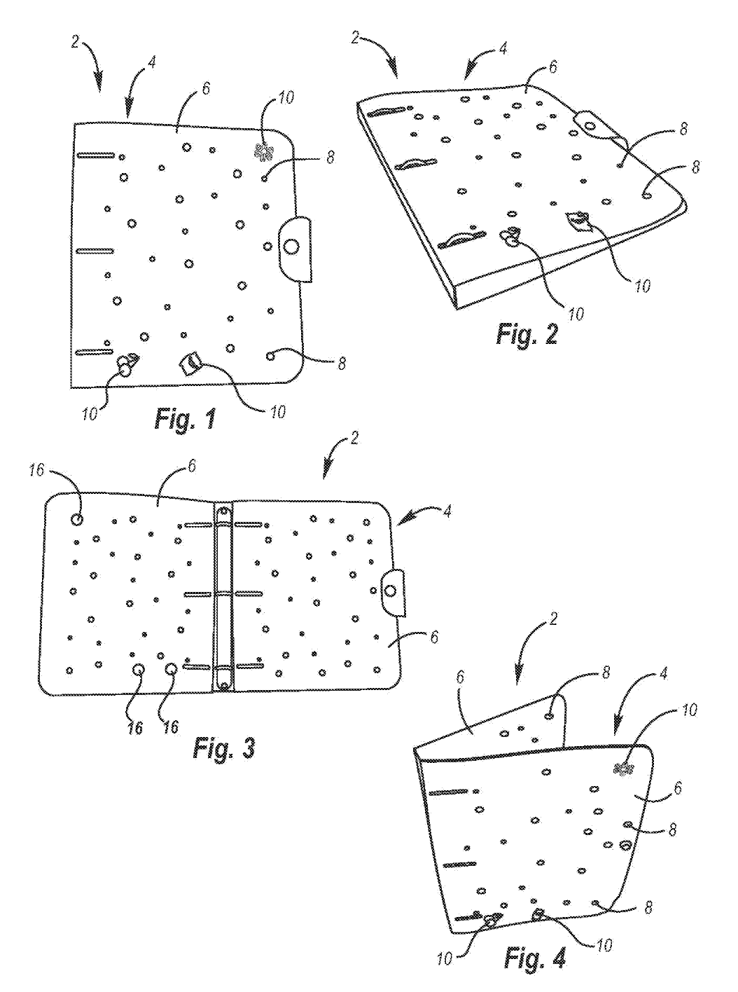

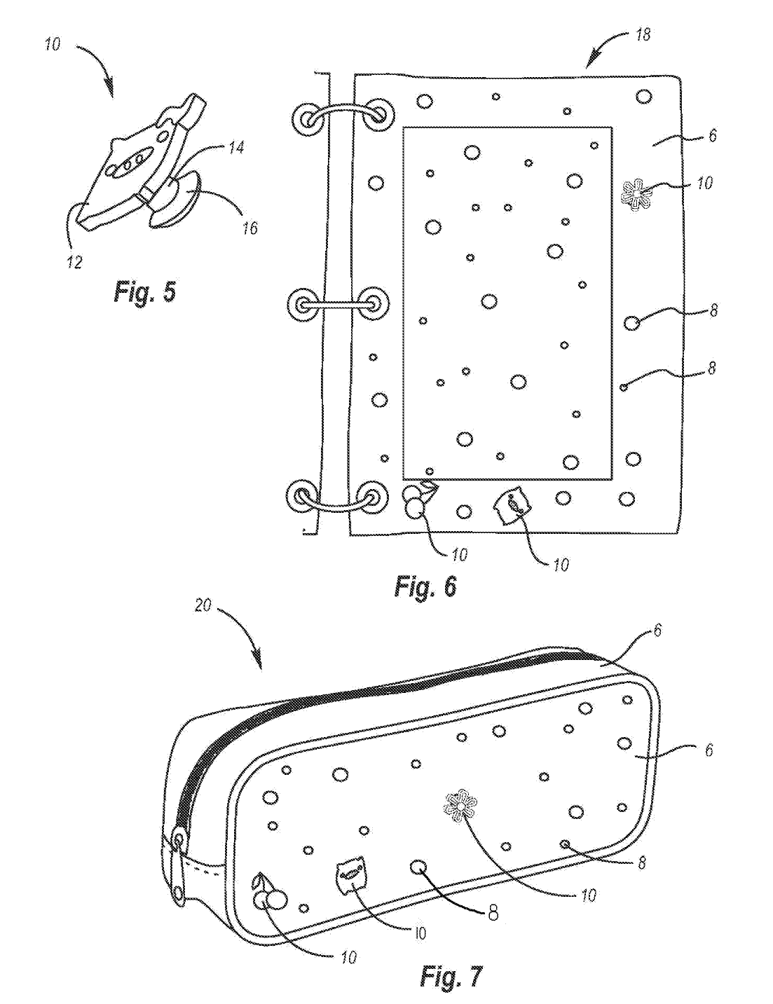

There are a wide variety of possible case system implementations. Notwithstanding, with reference to the non-limiting example provided with respect to FIGS. 1-4, various views of a first particular implementation of a case system comprising one or more cases having one or more removable, replaceable identification plugs (according to a first particular embodiment) is illustrated. Case system 2 comprises case 4, which comprises two or more surfaces 6. In particular implementations, at least one of the two or more surfaces 6 comprise one or more holes 8 sized and shaped to accept and maintain in position one or more identification plugs 10 (FIG. 5). In some particular implementations, one or more holes 8 may comprise one or more anchor points. It will be understood that an anchor point may comprise any fastener, hole, recess, groove, notch, loop, hook, eyelet, or any other point of attachment consistent with the disclosures contained herein. In some particular implementations, an anchor point may comprise a magnetic portion (a magnet and/or a magnetic metallic portion).

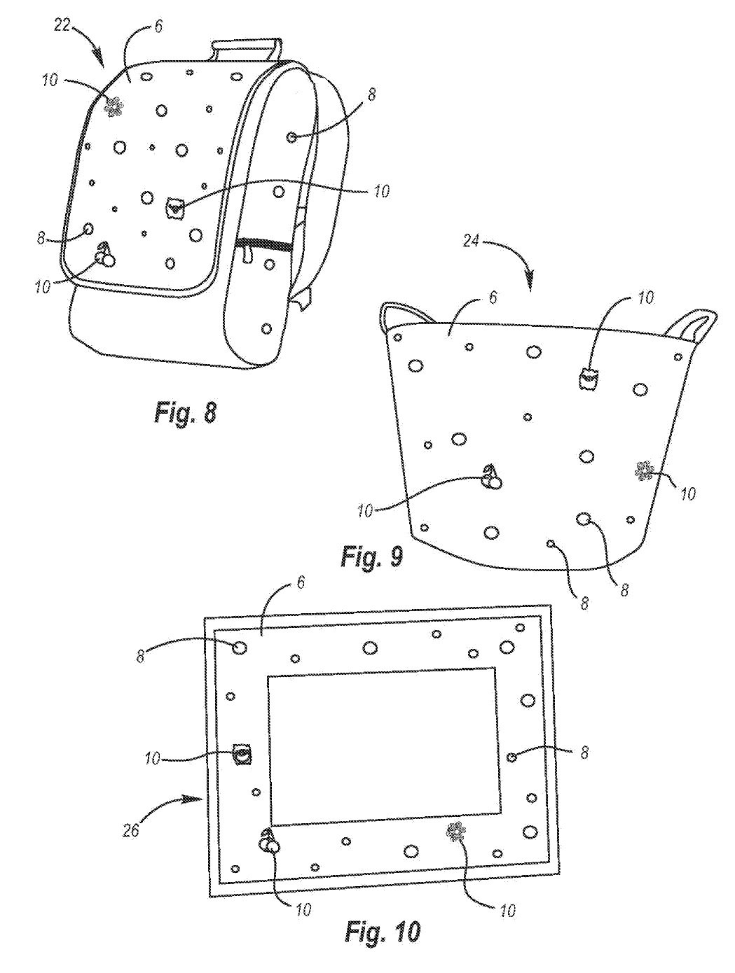

While case 4 is shown as a notebook-type case designed for holding three-hole punched paper (FIGS. 1-4), it will be understood that the principles disclosed with respect to FIGS. 1-4 may be applied to other types of cases (such as, by way of non-limiting example, those illustrated in FIGS. 6-10), for use in other particular implementations of case systems. In particular implementations, two or more surfaces 6 may oppose one another, such that at least one of the two or more surfaces 6 is opposite, or faces, at least one other of the two or more surfaces 6. In other particular implementations (such as the non-limiting example provided with respect to FIG. 8), two or more surfaces 6 may be adjacent to one another, such that at least one of the two or more surfaces 6 shares a border or edge with at least one other of the two or more surfaces 6. In addition to the foregoing, it will be understood two or more surfaces 6 may comprise any thickness, gauge and/or weight consistent with the disclosures contained herein.

As noted above, one or more holes 8 are disposed about at least one of the two or more surfaces 6. In some particular implementations, one or more holes 8 pass all the way through at least one of the two or more surfaces 6. In other particular implementations, one or more holes 8 do not pass all the way through at least one of the two or more surfaces 6. Accordingly, it will be understood that, one or more holes 8 may comprise a variety of depths. In some particular implementations, one or more holes 8 may be tapered so that one end of the hole 8 has a smaller diameter than another end of the same hole 8 (in such particular implementations, anchor 16 and/or retaining portion 17 may likewise comprise a tapered portion, complementary to the one or more holes 8). In other particular implementations, one or more holes may comprise a perimeter wall that is perpendicular to one or more surfaces 6. In some particular implementations having a plurality of holes 8, the depths of one or more holes 8 may all be the same (by way of non-limiting example, they may all pass through at least one of the two or more surfaces 6). In other particular implementations having a plurality of holes 8, the depths of at least two holes 8 may differ from one another (by way of non-limiting example, one hole 8 may pass all the way through surface 6, while one hole 8 may not pass all the way through. In still other particular implementations, at least one of the plurality of holes 8 is located substantially above at least one of the two or more surfaces 6. In those implementations where one or more holes 8 are located substantially above the one or more surfaces 6, the hole may be contained within a raised portion such as, by way of non-limiting example, a raised disk (which may be glued, plied, riveted, etc. to one or more surfaces 6). Notwithstanding, as will be described further with respect to FIG. 5, since one or more holes 8 are hole sized and shaped to accept and maintain in position one or more identification plugs, it will be understood that, whatever the particular 07 of a particular hole 8, a complementary identification plug to be accepted and maintained in position by one or more holes 8 may be provided.

Still referring to FIGS. 1-4, the plurality of holes 8 may comprise any variety of diameters. In some particular implementations, the diameter of each of the plurality of holes 8 may be equal. In other particular implementations, the plurality of holes 8 may each comprise a different diameter. In still other particular implementations, the plurality of holes 8 may comprise a variety of diameters. In addition, it will be understood that the plurality of holes 8 may each comprise a perimeter edge, the perimeter edge defining the shape of the hole. It will be further understood that the perimeter edge of each of the plurality of holes 8 may comprise any shape consistent with the disclosures contained herein. Therefore, the plurality of holes 8 may each comprise a circular, square, oval, rectangular, elliptical, oblong, triangular, quadrilateral, polygonal, pentagonal, hexagonal, heptagonal, octagonal, nonagonal, decagonal, or any other perimeter shape. It will be understood that, in any particular implementation, the plurality of holes 8 may comprise a plurality of hole shapes.

In addition to the foregoing, there are a plurality the plurality of holes 8 may be distributed about at least one of the two or more surfaces 6 in randomly or haphazardly. In other particular implementations, the plurality of holes 8 may be disposed or arranged about at least one of the two or more surfaces 6 in a systematic fashion such as, by way of non-limiting example, linearly (thereby arranging the plurality of holes 8 into rows, columns, diagonal rows, etc.) and/or curvilinearly (thereby forming circles, arcs, and the like). In addition, in those particular implementations where the plurality of holes 8 are disposed or arranged about at least one of the two or more surfaces 6 systematically, the plurality of holes 8 may be arranged so as to form a silhouette or outline of a item (Such as, by way of non-limiting example, an outline of a cartoon character, an outline of a sports team logo, an outline of a registered trademark, etc.). In some particular implementations, the plurality of holes 8 may be arranged equidistantly from one another. In other particular implementations, especially where the plurality of holes 8 are disposed randomly or haphazardly, the plurality of holes 8 may not be located equidistantly from one another.

Referring now to FIG. 5, a first particular a first particular embodiment of an identification plug is illustrated. Identification plug 10 comprises identification surface 12, post 14, and retaining portion 16. In some particular embodiments, retaining portion 16 may comprise anchor portion 17. Specifically, in those embodiments having one or more anchor points, one or more complementary anchors may be provided with one or more identification plugs, the anchors selectively mating with the one or more anchor points. In particular, in those embodiments having a magnetic anchor point, a magnetic (and/or magnetized metal) anchor may be provided. Similarly, in those particular embodiments where one or more anchor points comprise one or more holes, one or more anchors may comprise an anchor portion that may be impinged within the one or more holes. In some particular embodiments, identification plug may comprise two opposing retaining portion 16 and/or anchor portion 17. In those embodiments of identification plug having two opposing retaining portions 16 and/or anchor portions 17, one or more identification plugs 10 may be used to removably couple together two or more cases (such as any of the case implementations described herein). In particular, with a first retaining portion 16 and/or anchor portion 17 releasably coupled with a hole 8 and/or anchor point 8 of a first case (such as any of the case implementations described herein), a user may thereafter releasably couple a second retaining portion 16 and/or anchor portion 17 with a hole 8 and/or anchor point 8 of a first case (such as any of the case implementations described herein). In addition, users may attach items such as rulers, pencils and/or other items to one or more cases via one or more identification plugs 10 in the foregoing manner.

As noted above with respect to FIGS. 1-4, each of the plurality of holes 8 are sized and shaped to accommodate and maintain in position therein one or more identification plugs 10. In particular implementations, identification surface 10 may comprise one or more of: a cartoon character; sportsman/woman likeness; sportsman/woman jersey or car number; sports team logo; trademarked logo; copyrighted image; number; symbol; word and/or expression; personal or company name; picture or photograph; trademark slogan; and/or any other shape, figure or design consistent with the disclosures contained herein. In other particular implementations, identification surface may comprise a souvenir or commemorative information relating to a particular location, destination, company, business, event, or any other information. In any event, a user may selectively couple/decouple on or more identification plugs 10 with one or more holes 8.

Referring still to the first particular embodiment of identification plug 10 illustrated in FIG. 5, a user desiring to couple one or more identification plugs 10 with one or more holes 8 may begin by inserting retaining portion 14 of identification plug 10 through hole 8. In those particular implementations where the perimeter edge of one or more holes 8 is pliable, the perimeter edge of hole 8 may flex to allow retaining portion 16 to pass therethrough. Notwithstanding, in those particular implementations where the perimeter edge of one or more holes 8 is not pliable, retaining portion 16 may be formed of a pliable material to allow the passage of retaining portion 16 through one or more holes 8. Whether or not one or more holes 8 and/or one or more retaining portions 16 are pliable, it will be understood that one or more identification plugs 10 according to the first embodiment may be maintained in position with respect to one or more holes 8 (and thereby one or more surfaces 6), via the impingement of one or more surfaces 6 between identification surface 12 and retaining portion 16. In some particular embodiments, retaining portion 16 may comprise any surface with a diameter equal to or larger than one or more holes 8. It will be further understood that with one or more surfaces 6 impinged between one or more identification surfaces 12 and one or more retaining portions 16, one or more posts 14 may pass through one or more holes 8. Notwithstanding, in particular embodiments, retaining portion 16 may be eliminated. In those particular embodiments of an identification plug eliminating retaining portion 16, the identification plug is maintained in position with respect to one or more holes 8 via the impingement of post 14 in one or more holes 8. Therefore, in those particular embodiments of an identification plug eliminating retaining portion 16, a diameter of post 14 may be substantially equal to a diameter of one or more holes 8. It will be understood by those having ordinary skill in the art that if the diameter of post 14 is too small with respect to the diameter of one or more holes 8, that post 14 may not be maintained in position with respect to the one or more holes 8. In addition, it be further understood by those having ordinary skill in the art that if the diameter of post 14 is too large with respect to the diameter of one or more holes 8, that post 14 may not fit within the one or more holes 8. In any event, it will be understood that, in particular embodiments/implementations, the shape of post 14 is complementary to the shape of one or more holes 8, so that a complementary fit is achieved between post 14 and one or more holes 8. In other particular implementations, the shape of post 14 is not complementary to one or more holes 8, such that the fit is achieved between post 14 and one or more holes 8 is not complementary. In those particular embodiments/implementations where the fit achieved between post 14 and one or more holes 8 is not complementary, a gap may appear between the edge of one or more holes 8, and one or more posts 14.

As described above, in particular implementations, a case 4 (and/or other particular implementations of cases as described with regard to the non-limiting examples provided in FIGS. 6-10), may comprise one or more holes that do not pass all the way through at least one of the two or more surfaces 6. Likewise, as described above, one or more holes 8 may comprise a notch or groove disposed within the one or more holes (whether or not the one or more holes is located above one or more surfaces 6). In those particular implementations where one or more holes 8 comprises a notch or groove therein, retaining portion 16 may “snap” or otherwise fit into place with respect to the notch or groove. Accordingly, it will be understood that the mechanical cooperation of retaining portion 16 and one or more holes 8, in some particular embodiments/implementations, may behave as a snap fastener, providing a removably interlocking fit between retaining portion 16 and a groove in one or more holes 8.

Still referring to FIG. 5, in particular embodiments, identification plug 10 may comprise one or more metallic or magnetic portions, which may magnetically attract to one or more complementary metallic and/or magnetic portions comprising one or more holes 8. In some particular embodiments/implementations, a removable magnetic coupling between one or more identification plugs 10 and one or more holes 8 may be provided. Specifically, retaining portion 16, post 14, identification surface 12, and/or one or more holes 8 could each be formed of magnetized material, which may provide a removably magnetic coupling between one or more identification plugs 10 and one or more holes 8.

Referring now to FIGS. 6-10, a variety of case implementations are shown. It will be understood that the cases and/or identification plugs described herein may be provide separately, or may be provided in a system implementation. FIG. 6 illustrates a non-limiting example of a pencil case 18 according to the present disclosure. FIG. 7 illustrates another non-limiting example of a pencil case 20. FIG. 8 shows a non-limiting example of a backpack 22 according to the present disclosure. FIG. 9 shows a non-limiting example of a toy tote 24 according to the present disclosure. FIG. 10 illustrates a non-limiting example of a picture case/frame 26 according to the present disclosure. While various case implementations are shown and described with respect to FIGS. 6-10, it will be understood that many other case possibilities, consistent with the disclosures contained herein, are possible. Additional non-limiting examples of cases may include luggage cases, suitcases, valises, trunks, overnight cases, travel cases, purses, handbags, or any other cases used to store and transport personal effects.

It will be understood that a case system comprising one or more cases having one or more removable, replaceable identification plugs, cases having one or more holes sized and shaped to accommodate one or more identification plugs and/or identification plugs configured to selectively mate with one or more holes are not limited to the specific parts, devices and components disclosed in this document, as virtually any parts, devices and components consistent with the intended operation of a case system comprising one or more cases having one or more removable, replaceable identification plugs, cases having one or more holes sized and shaped to accommodate one or more identification plugs and/or identification plugs configured to selectively mate with one or more holes may be utilized. Accordingly, for example, although particular case systems, cases, surfaces, holes, identification plugs, posts, retaining portions, and other parts, devices and components are disclosed, such may comprise any shape, size, style, type, model, version, class, measurement, concentration, material, weight, quantity, and/or the like consistent with the intended operation of case system implementations. Implementations and embodiments are not limited to uses of any specific parts, devices and components; provided that the parts, devices and components selected are consistent with the intended operation of a luggage case having a built in luggage scale implementation.

Implementations of a case system comprising one or more cases having one or more removable, replaceable identification plugs, cases having one or more holes sized and shaped to accommodate one or more identification plugs and/or identification plugs configured to selectively mate with one or more holes, and implementing components, may be constructed of a wide variety of materials. For example, the components may be formed of: polymers such as polychloroprene; thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; glasses (such as fiberglass), carbon-fiber, aramid-fiber, any combination thereof, and/or other like materials; composites and/or other like materials; natural and synthetic fabrics, such as nylon, canvas, leather, and/or other like materials; metals, such as zinc, magnesium, titanium, copper, lead, iron, steel, carbon steel, alloy steel, tool steel, stainless steel, brass, tin, antimony, aluminum, any combination thereof, and/or other like materials; permanent magnets; alloys, such as aluminum alloy, titanium alloy, magnesium alloy, copper alloy, any combination thereof, and/or other like materials; any other suitable material; and/or any combination of the foregoing thereof.

Some components defining a case system comprising one or more cases having one or more removable, replaceable identification plugs, cases having one or more holes sized and shaped to accommodate one or more identification plugs and/or identification plugs configured to selectively mate with one or more holes, and implementing components may be manufactured simultaneously and integrally joined with one another, while other components may be purchased pre-manufactured or manufactured separately and then assembled with the integral components. Various implementations may be manufactured using conventional procedures as added to and improved upon through the procedures described here. For the exemplary purposes of this disclosure, at least second case 4 and identification plug 10 may be formed separately.

Accordingly, manufacture of these components separately or simultaneously may involve vacuum forming, injection molding, blow molding, casting, forging, cold rolling, milling, drilling, reaming, turning, grinding, stamping, pressing, cutting, bending, welding, soldering, hardening, riveting, punching, plating, and/or the like. Components manufactured separately may then be coupled or removably coupled with the other integral components in any manner, such as with adhesive, a rivet, a weld joint, a solder joint, a fastener, washers, retainers, wrapping, wiring, any combination thereof, and/or the like for example, depending on, among other considerations, the particular material forming the components.

Contemplated implementations of a case system comprising one or more cases having one or more removable, replaceable identification plugs, cases having one or more holes sized and shaped to accommodate one or more identification plugs and/or identification plugs configured to selectively mate with one or more holes are many and can apply in many situations. While the specific implementations of a case system comprising one or more cases having one or more removable, replaceable identification plugs, cases having one or more holes sized and shaped to accommodate one or more identification plugs and/or identification plugs configured to selectively mate with one or more holes, and implementing components may initially be particularly useful in assisting users to customize and identify their cases, they also have many additional implementations in various other applications for which the desirability of the capabilities of the devices described will become readily apparent from the present disclosure. The specific parts, devices and components discussed in this application in no way restrict any possible implementation of the principles here disclosed. Additionally, while particular examples of components may be described in this disclosure, these examples do not serve to limit in any way the potential types of components or reconfigurability that may be implemented. Those skilled in the art will be able with the principles here disclosed to create many potential implementations.

1. A case system comprising a case and one or more identification plugs, wherein:
the case comprises two or more surfaces, at least one surface of the two or more surfaces comprising a plurality of holes disposed thereabout, the plurality of holes sized and shaped to accept and maintain in position one or more identification plugs; and
the one or more identification plugs comprise a post portion sized and are sized and shaped to selectively mate with at least one of the plurality of holes.

2. The system of claim 1, wherein at least two of the two or more surfaces one of oppose one another and are adjacent to one another.

3. The system of claim 1, wherein the plurality of holes are one of: disposed randomly about the at least one surface; arranged linearly about the at least one surface; arranged curvilinearly about the at least one surface; arranged equidistantly with respect to one another about the at least one surface; and arranged to form one or more designs about the at least one surface.

4. The system of claim 1, wherein the plurality of holes are each one of substantially equal in diameter and comprise a variety of diameters.

5. The system of claim 1, wherein the plurality of holes comprise a variety of depths.

6. The system of claim 5, wherein at least one of the plurality of holes pass through the at least one surface.

7. The system of claim 1, wherein the plurality of holes comprise a variety of perimeter shapes.

8. The system of claim 1, wherein at least a portion of at least one of the plurality of holes is located substantially above the at least one surface.

9. The system of claim 1, wherein the one or more identification plugs further comprise an identification portion coupled with the post portion.

10. The system of claim 1, wherein the one or more identification plugs further comprise a retaining portion coupled with the post portion.

11. The system of claim 1, wherein a shape of the post portion is complementary to a shape of one or more of the plurality of holes.

12. A case system comprising a case and one or more identification plugs, wherein:
the case comprises two or more surfaces, at least one surface of the two or more surfaces comprising a plurality of anchor points disposed thereabout, the plurality of anchor points sized and shaped to accept and maintain in position one or more identification plugs; and
the one or more identification plugs comprise an anchor portion sized and shaped to selectively mate with at least one of the plurality of anchor points.

13. The system of claim 12, wherein at least two of the two or more surfaces one of oppose one another and are adjacent to one another.

14. The system of claim 12, wherein the plurality of anchor points are one of: disposed randomly about the at least one surface; arranged linearly about the at least one surface; arranged curvilinearly about the at least one surface; arranged equidistantly with respect to one another about the at least one surface; and arranged to form one or more designs about the at least one surface.

15. The system of claim 12, wherein the plurality of anchor points comprise a variety of depths.

16. The system of claim 12, wherein at least one of the plurality of anchor points passes through the at least one surface.

17. The system of claim 1, wherein the plurality of anchor points comprise a variety of perimeter shapes.

18. The system of claim 1, wherein at least a portion of at least one of the plurality of anchor points is located substantially above the at least one surface.

19. The system of claim 1, wherein the one or more identification plugs further comprise an identification portion coupled with the anchor portion.

20. The system of claim 1, wherein the one or more identification plugs further comprise a retaining portion coupled with the anchor portion.

21. The system of claim 1, wherein a shape of the anchor portion is complementary to a shape of one or more of the plurality of anchor points.

22. A case comprising two or more surfaces, at least one surface of the two or more surfaces comprising a plurality of holes disposed thereabout, the plurality of holes sized and shaped to accept and maintain in position one or more identification plugs.

23. The case of claim 22, wherein the one or more identification plugs are maintained in position with respect to at least one of the plurality of holes via impingement of an identification plug retaining portion upon the at least one surface.

24. The case of claim 22, wherein the one or more identification plugs are maintained in position with respect to at least one of the plurality of holes via the impingement of an identification plug retaining portion within at least one of the one or more holes.

25. The case of claim 22, wherein the one or more identification plugs are maintained in position with respect to at least one of the plurality of holes via the impingement of a identification plug post portion within the at least one surface.
